(19) United States
(12) Patent Application Publication
(10) Pub. No.: US 2005/0189078 A1
(43) Pub. Date: Sep. 1, 2005

(54) Automated venetian blinds

(76) Inventor: Greg Whiting, Nevada, TX (US)

Correspondence Address: HOWISON & ARNOTT, L.L.P, P.O. BOX 741715, DALLAS, TX, 75374-1715, US

(21) Appl. No.: 11/048,411

(22) Filed: Feb. 1, 2005

Related U.S. Application Data
(63) Continuation-in-part of application No. 10/361,417, filed on Feb. 10, 2003.
(60) Provisional application No. 60/371,220, filed on Apr. 5, 2002.

(51) Int. Cl. E06B 9/32

(52) U.S. Cl. 160/176.1 P

(57) ABSTRACT

An automated blind assembly is disclosed including a shaft connected to a rotatable slat and a motor connected to the shaft. The motor operates to rotate the shaft and thereby rotate the rotatable slat.

### CROSS-REFERENCE TO RELATED APPLICATIONS

This application is Continuation-in-Part application of U.S. Ser. No. 10/361,417, which was filed on Feb. 10, 2003, which claims priority on U.S. Provisional Patent Application Ser. No. 60/371,220 filed Apr. 5, 2002 entitled “Auto Blinds”

### TECHNICAL FIELD OF THE INVENTION

This invention is related to window dressings, in particular to motorized blinds.

### BACKGROUND OF THE INVENTION

Venetian blinds have long been popular as an attractive way to manage window light and visibility. The sequence of suspended slats can be raised and lowered. The slats can be rotated to allow direct sunlight, diffused sunlight or to close off a substantial portion of the light.

During the course of a day, the sunlight incident on the blinds changes significantly. Blinds may be set to allow maximum lighting before the sun sets and then closed entirely after dark to keep outsiders from seeing into the room. Ideally, the slats may be rotated from one position to another five times between sunrise and sunset. Often times, however, the bother of altering the blinds is sufficient to keep someone from using the blinds to their best advantage.

It would therefore be advantageous to have a blind that was simple to adjust. It would also be advantageous to have a blind that automatically adjusted itself, either in response to a preset program or in response to the outside lighting conditions.

### SUMMARY OF THE INVENTION

An automated blind assembly is disclosed including a shaft connected to a rotatable slat and a motor connected to the shaft. The motor operates to rotate the shaft and thereby rotate the rotatable slat.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a first embodiment of an automated blind;

FIG. 2 illustrates a second embodiment of an automated blind;

FIG. 3 illustrates a first head rail assembly;

FIG. 4 illustrates a second head rail assembly;

FIG. 5 illustrates a programmable interface faceplate;

FIG. 6 illustrates a functional diagram of a programmable interface;

FIG. 7 illustrates a motor assembly;

FIG. 8 illustrates a baton clutch;

FIG. 9 illustrates an initialization flowchart;

FIG. 10 illustrates a position reference wheel;

FIGS. 10a, 10b and 10c illustrate position timing diagrams;

FIG. 11 illustrates a cross-sectional view of an engaged clutch mechanism; and

FIG. 12 illustrates a cross-sectional view of a dis-engaged clutch mechanism.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

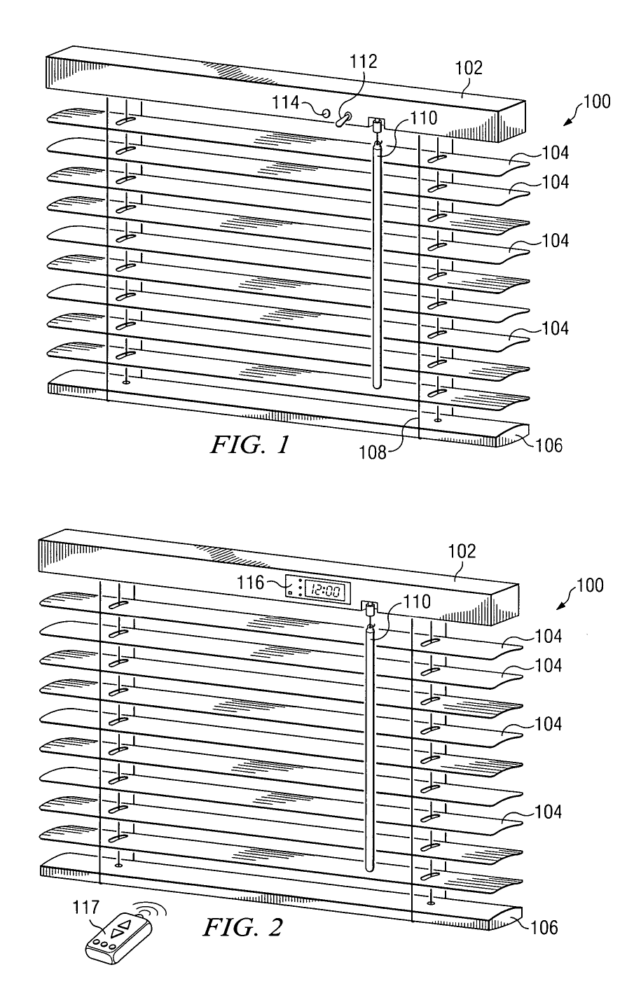

With reference to FIG. 1, a first embodiment of the automated venetian blind is shown. As shown, the automated venetian blind 100 generally has the outward appearance of a standard venetian blind. The venetian blind may be a horizontal blind, a vertical blind, a mini blind or any other rotating slat blind assembly.

The automated venetian blind 100 includes a head rail 102. The head rail 102 contains mechanisms for raising, lowering and rotating the slats 104. The head rail 102 is attached by two or more lift cords 108 to a bottom rail 106. The lift cords 108 are typically in a ladder formation to facilitate rotation of the slats 104. A set of slats 104 are held suspended by the lift cords 108 to fill the space between the head rail 102 and the bottom rail 106. A baton 110 is attached to the head rail 102. Rotating the baton 110 rotates the slats between full open and full close positions.

An on-off switch 114 is mounted on the head rail 102. The on-off switch 114 is used to start and stop the rotation of the slats 104. Direction switch 112 may be switched between two positions. The direction switch 112 sets the direction of slat rotation. When the direction switch 112 is placed in a first position, the slats 104 rotate clockwise. When the direction switch 112 is placed in a second position, the slats 104 rotate counter-clockwise.

With reference to FIG. 2, a second embodiment of the automated venetian blind 100 is shown. In this embodiment, a programmable interface 116 is mounted on the face of head rail 104. The programmable interface 116 may control the rotation of the slats in accordance with event programming, remote control instructions and/or light sensors. An infrared remote control 117 may be used to communicate with the programmable interface 116.

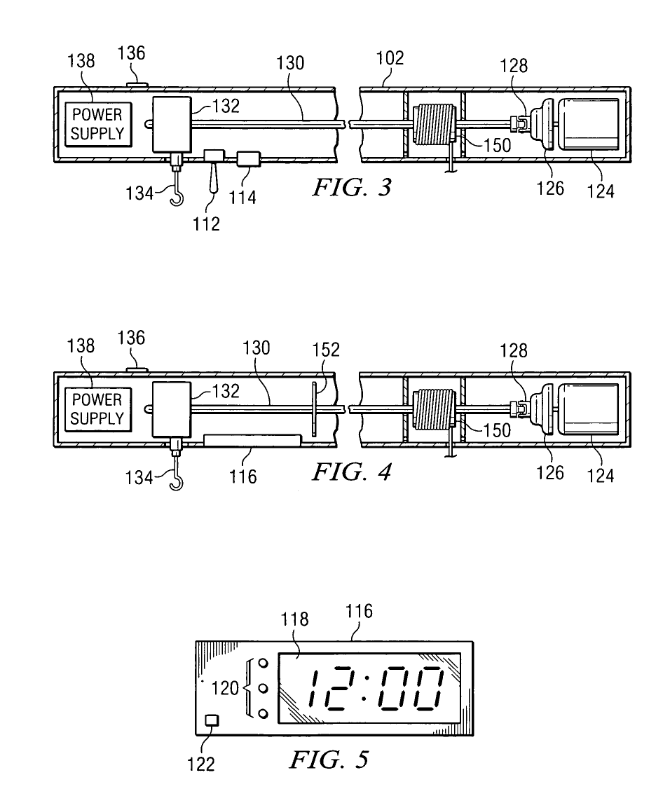

With reference to FIG. 3 and FIG. 4, the internal mechanisms of the head rail 102 are shown. The lift cords 108 of the venetian blinds are connected to spools 150. The spools 150 are attached to a shaft 130. By rotating the shaft 130, the spools 150 rotate causing the lift cords 108 to wind or unwind from the spools 150. This winding of the lift cords 108 around the spools 150 causes the slats 104 to rotate.

The shaft 130 is attached to a coupler 128. The coupler 128 is connected to the gear shaft of gear box 126, providing a mechanical connection of the shaft 130 to the gear shaft. Gear box 126 is connected to a motor 124. When the motor is powered, the shaft 130 rotates in either a clockwise or counter-clockwise direction, depending on the direction of the motor's rotation. Gear box 126 is set at a 50-to-1 ratio in the preferred embodiment.

A baton hook 134 is joined to the shaft 130 using a baton clutch 132. The baton clutch 132 rotates the shaft 130 in response to rotation of a baton 110 attached to the baton hook 134. The baton clutch 132 is designed to allow the baton 110 to be engaged or disengaged. When the baton clutch 132 is engaged, the rotation of the baton 110 causes the shaft 130 to rotate. When the baton clutch 132 is disengaged, the baton 110 is disconnected from the shaft 130, so that rotation of the baton 110 does not rotate the shaft 130. The baton clutch 132 is disengaged when the motor 124 is used to rotate the shaft 130, because the force necessary to rotate the baton 110 by rotating the shaft 130 is prohibitive. The baton clutch 132 is engaged to allow for manual adjustment of the slats 104.

A power supply 138 provides power to the motor 124, programmable interface 116 and other components as necessary. In the preferred embodiment, power supply 138 is a 9 volt battery. As will be recognized by those having skill in the art, power may be supplied using any number of well known power supplies. Photocell 136 may be used to provide solar power.

The automated venetian blind has one more controls to control the functions of the blinds. With reference to FIG. 3, an on/off switch 114 is provided. The on/off switch 114 starts and stops the motor 124. A direction switch 112 is provided to control the motor's direction of rotation. When the direction switch 112 is placed in a first position, the motor 124 rotates in a clockwise direction. When the direction switch 112 is placed in a second position, the motor 124 rotates in a counter-clockwise direction.

With reference to FIG. 4, a programmable interface 116 is provided to control the operation of the automated venetian blinds.

A position reference wheel 152 is attached to shaft 130 so that rotation of the shaft 130 causes rotation of the position reference wheel 152. An LED and photocell (not shown) connected to the programmable interface are used to detect the transmission of light through the position reference wheel 152. The position reference wheel is divided into angle segments of varying width. A first home segment 184 is transparent to light. The first home segment 184 is wider than the pulse segments 186 and 188. The first home segment 184 defines the first home position for the shaft. When the programmable interface 166 detects the first home segment 184, the slats 104 are completely closed and the shaft will be rotated in a counter-clockwise direction to open the slats 104. First pulse segments 186 have an opaque space in a first location on the first pulse segments 186. Second pulse segments 188 have an opaque space in a second location on the second pulse segments 188, where the second location is measurably different than the first location.. By detecting the passage and sequence of the opaque spaces on the first and second pulse segments 186 and 188, the programmable interface 116 can determine the direction of shaft rotation and the position of the shaft, relative to the first home segment 184. A second home segment 190 is transparent to light. The second home segment 190 is wider than the pulse segments 186 and 188. The second home segment 190 defines a second home position for the shaft 130.

The mechanisms of the automated blind assembly, including the motor, power supply, control circuits and sensors are all contained within the head rail. Because the aesthetics of blinds may be as important as their utility, having an automated blind assembly that is small enough to fit completely within the head rail is advantageous. The automated blind assembly can also be fashioned to fit within virtually any head rail, allowing the aesthetics to remain substantially unchanged while providing automated blind functionality.

With reference to FIG. 5, a faceplate for the programmable interface is shown. The programmable interface 116 includes a display 118. The display 118 is preferably a LCD display, but other forms of display may be used as appropriate to the implementation. The programmable interface 116 includes one or more programming buttons 120. As shown, the programmable interface 116 includes three programming buttons 120 which may be used to program various operations. One having ordinary skill in the art will appreciate that the nature of a given implementation may call for more or less programming buttons or even other forms of input. For example, an infrared receiver 122 allows the programmable interface 116 to communicate with a remote control device. If connected to a computer network, the programmable interface 116 could be programmed using a personal computer or other networked device.

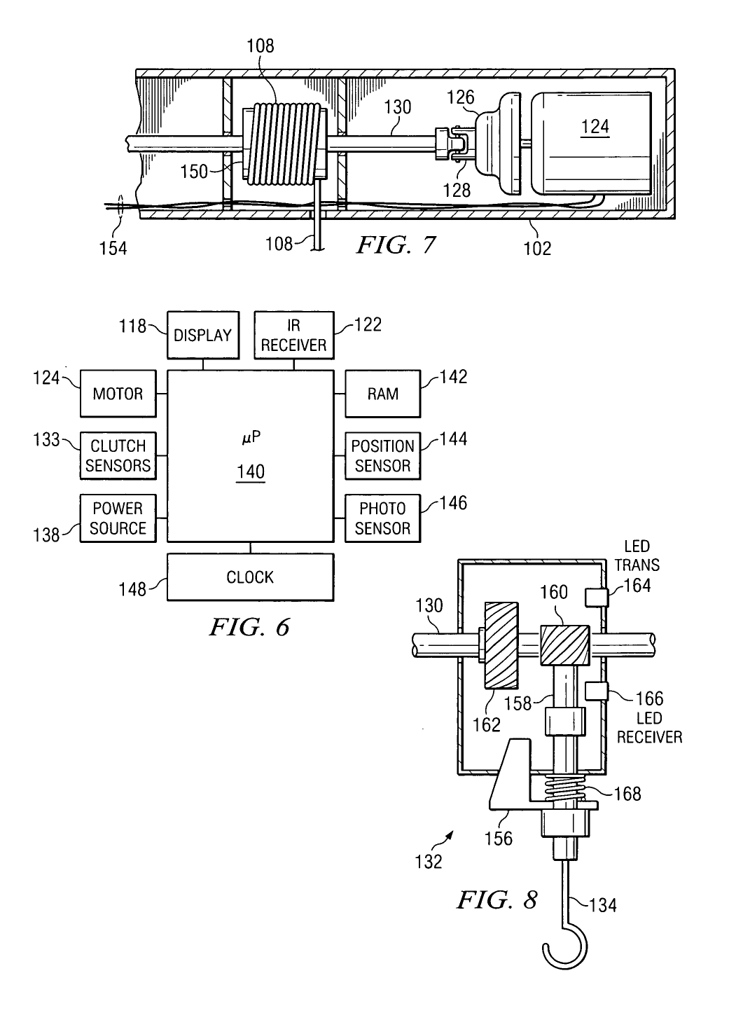

With reference to FIG. 6, a functional diagram of the components of programmable interface 116 is shown. Microprocessor 140 controls the operation of the programmable interface 116. The microprocessor 140 is connected to memory 142 which may store programming instructions, a schedule of events or other data pertaining to the position and motion of the shaft 130, baton clutch 132 or slats 104. The microprocessor 140 also includes a real time clock 148. The real time clock 148 is preferably built into the microprocessor 140. The real-time clock 148 is used to accurately track the time by the microprocessor 140. The microprocessor 140 is connected to the infrared receiver 122 for communication with an infrared remote control device 117. The microprocessor 140 receives power from, power source 138. A photo sensor 146 provides a microprocessor 140 with information about ambient light conditions. A display 118 is used by the microprocessor 140 to display system information or the time. Position sensors 144 provides information to the microprocessor about the position of position reference wheel 152. The motor 124 is controlled by the microprocessor 140. Clutch sensors 133 detect the engage/disengage status of the baton clutch 132.

With reference to FIG. 7, details of the motor assembly is shown. Motor 124 is nested inside of the head rail box 102. The drive of the motor 124 is connected to gear box 126. The gear box 126 is connected to coupler 128. The coupler 128 connects the motor assembly to the shaft 130. A spool 150 is connected to the lift cords 108 of the venetian blind. Wiring 154 is provided to send power to the motor 124 from the power supply 138. The wiring 154 may also be used to send control signals to the motor 124 from the programmable interface 116.

With reference to FIG. 8, the baton clutch is shown in detail. The baton clutch 132 is connected to the shaft 130. A baton hook 134 is connected to a spring-loaded wedge 156. A spring 168 keeps the wedge in place until moved manually by a user. The baton shaft 158 connects the baton hook 134 to a rod gear 160. The rod gear may be moved along the shaft to engage or disengage the shaft gear 162. An LED transmitter 164 and receiver 166 interact with clutch sensors 133 to communicate the status of the baton clutch 132. When the baton is engaged, the LED 164 is used to communicate this information to the microprocessor 140 so that the motor will not be turned on until the baton clutch has been disengaged.

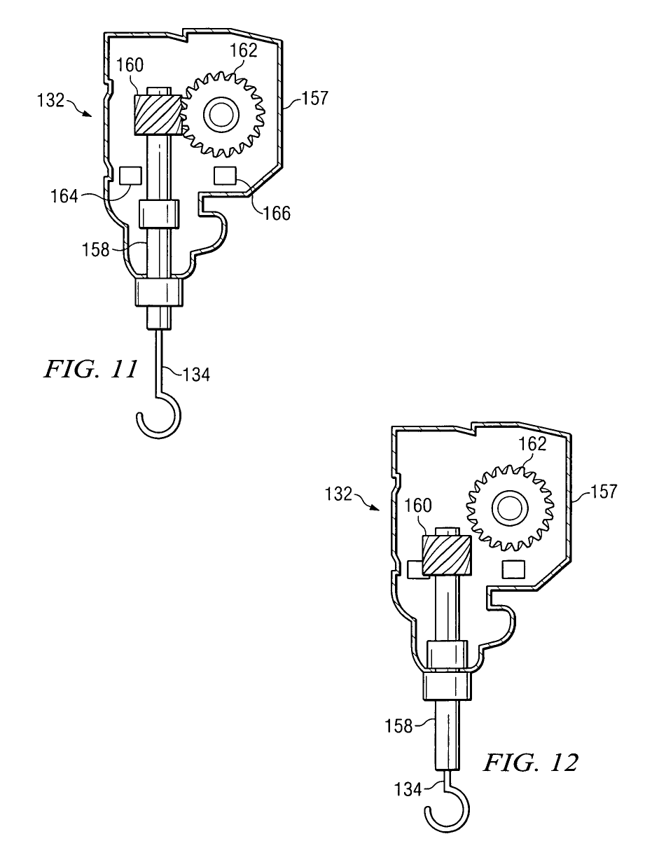

With reference to FIG. 11, a cross sectional view of an engaged clutch mechanism 132 having a housing 157 is shown. Rod gear 160 engages the shaft gear 162 when force is applied along the baton shaft to lift the shaft gear 162. The force may be applied by a spring 168 or by manual pressure applied by a user.

With reference to FIG. 12, a cross-sectional view of a disengaged clutch mechanism 132 is shown. Rod gear 160 is disengaged from the shaft gear 162 such that motion of the shaft gear 162 does not move the rod gear 160. In accordance with one embodiment, the clutch mechanism 132 is biased so that the rod gear 160 is normally disengaged from the shaft gear 162 unless action is taken to engaged the mechanism.

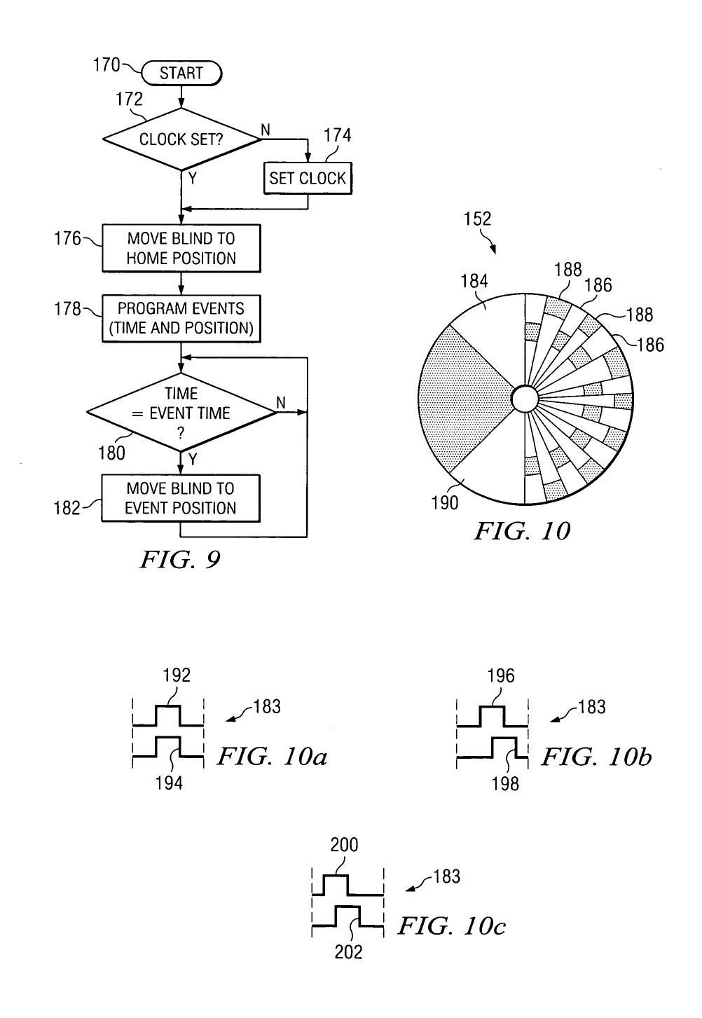

FIG. 9 depicts initialization flowchart for the automated venetian blind system. When the system is powered up, the process begins in start step 170. The microprocessor initially checks to see if the real-time clock 148 has been set in step 172. If the clock has not been set, then the user follows standard clock-setting protocols, such as used in a digital alarm clock, to set the clock 174.

Once the real-time clock 148 has been set, the microprocessor 140 operates the motor 124. Using the position reference wheel 152, the microprocessor 140 determines the direction of the shaft's rotation and operates the motor 124 so that the shaft is moved to the position defined by the first home segment 1184 of the position reference wheel 152 in step 176. The microprocessor 140 then checks the memory 142 to determine if events have been programmed. The events are programmed to define both a time of rotation and the position to which the blinds will be moved. Once the program events have been programmed, the microprocessor 140 repeatedly checks to see if the real-time as provided by the real-time clock is equal to an event time. When the time equals the first event time in step 180, then the shaft is rotated using the motor to the first event position in step 182. Once the blind has been moved to the first event position, the microprocessor 140 waits for the second event time, when the motor 124 will be engaged to rotate the shaft 130 to a second event position. This process continues until all the event times have elapsed.

Preferably, the programmed events define times during a single day when the shaft will be rotated. Once the sequence of events are executed in a first day, the same sequence is repeated for a second day. Clearly, the events could be defined for an entire week or any other period of time, providing different settings for each day's events.

FIG. 10 depicts a standard position reference wheel 152. Light transmitted through the position reference wheel can be detected to determine the sequence of opaque and tranparent spaces as the shaft rotates. First home position 184 represents a blind turned completely in one direction while the second home position 190 represents a blind turned completely in the opposite direction. Alternating segments 188 and 186 represent blind movement by discrete angles. FIG. 10a depicts the pulses created in response to transmitted light when the position reference wheel 152 is at the first home position 184. Two photosensor detect the transmitted light to generate pulses. In the home position, the first pulse 192 is transmitted and the second pulse 194 is positively reflected. This signal is generated in response to an upper transparent region and a lower transparent region, hence the home position. FIG. 10b shows the pulses generated as the shaft is rotated in a clockwise direction. The second pulse 198 trails the first pulse 196, the pattern created by clockwise rotation. FIG. 10c shows the pulses generated as the shaft is rotated in a counter-clockwise direction. The first pulse 200 leads the second pulse 202, the pattern created by counter-clockwise rotation. In this way, the microprocessor can register the direction of rotation and position of the blinds.

The microprocessor keeps track of the last three time counts as a reference, so that when the microprocessor receives a movement command, it can calculate how many time counts must be moved. The number of time counts from the first home position to the second home position is stored and is used to limit the movement of the blinds.

Although the preferred embodiment has been described in detail, it should be understood that various changes, substitutions and alterations can be made therein without departing from the spirit and scope of the invention as defined by the appended claims.

1: An automated blind assembly comprising:
a shaft connected to a rotatable slat;
a motor connected to the shaft; wherein the motor operates to rotate the shaft and thereby rotate the rotatable slat; and
a baton for manually rotating the shaft and a baton clutch for manually disengaging the baton from the shaft such that rotation of the baton does not cause rotation of the shaft.

2: The automated blind assembly of claim 1, further comprising a baton clutch sensor for determining if the clutch is engaged wherein operation of the motor is prevented when the clutch is engaged.

3: The automated blind assembly of claim 1, further comprising a switch to start and stop the motor.

4: The automated blind assembly of claim 1, further comprising a switch to change the direction of rotation of the motor.

5: The automated blind assembly of claim 1, further comprising a photocell to supply power to the motor.

6: The automated blind assembly of claim 1, further comprising a microprocessor programmed to control the motor.

7: The automated blind assembly of claim 6, wherein said microprocessor is programmed with events, such that upon the occurrence of an event, the microprocessor causes the motor to rotate the shaft to a defined position.

8: The automated blind assembly of claim 7, further comprising a light sensor, wherein said microprocessor is programmed to cause the motor to rotate the shaft in response to light conditions detected by said light sensor.

9: The automated blind assembly of claim 6, further comprising a remote control in communication with said microprocessor, such that instructions are transmitted by the remote control the microprocessor.

10: The automated blind assembly of claim 9, wherein said remote control is used to program said microprocessor.

11: The automated blind assembly of claim 9, wherein said remote control is used to instruct the microprocessor to cause the motor to rotate the shaft.

12: An automated blind assembly comprising:
a shaft connected to a rotatable slat;
a motor connected to the shaft; wherein the motor operates to rotate the shaft and thereby rotate the rotatable slat; and
a baton rotatably connectable to the shaft and a baton clutch for manually engaging the baton to the shaft such that rotation of the baton causes rotation of the shaft.

13: The automated blind assembly of claim 12, further comprising a baton clutch sensor for determining if the clutch is engaged wherein operation of the motor is prevented when the clutch is engaged.

14: The automated blind assembly of claim 12, further comprising a switch to start and stop the motor.

15: The automated blind assembly of claim 12, further comprising a switch to change the direction of rotation of the motor.

16: The automated blind assembly of claim 12, further comprising a photocell to supply power to the motor.

17: The automated blind assembly of claim 12, further comprising a microprocessor programmed to control the motor.
